(19) United States
(12) Patent Application Publication
(10) Pub. No.: US 2003/0200123 A1
(43) Pub. Date: Oct. 23, 2003

(54) Injury analysis system and method for insurance claims

(76) Inventors: John R. Burge, Redondo Beach, CA (US); Robert Thibodeau, Huntsville, AL (US)

Correspondence Address: Eric K. Satermo, Registered Patent Agent, P.O. Box 19099, Irvine, CA, 92623-9099, US

(21) Appl. No.: 10/274,304

(22) Filed: Oct. 18, 2002

Related U.S. Application Data
(60) Provisional application No. 60/347,924, filed on Oct. 18, 2001.

(51) Int. Cl. G06F 17/60; G06G 7/48

(52) U.S. Cl. 705/4; 703/6

(57) ABSTRACT

A system and method for using simulation to evaluate the injury claims of individuals involved in motor vehicle accidents. The system uses a computer system configured to accept accident data collected during the insurance claims process, provide an analysis of the impact forces and provide information about the forces and accelerations on body parts of the individuals claiming injuries. By substantially automating the conversion of accident data into occupant dynamics simulation information, injury claims can be cost-effectively analyzed using simulation.

### FIELD OF THE INVENTION

This invention relates to simulation systems that assist users in reconstructing automobile accidents.

### BACKGROUND OF THE INVENTION

Fraud is an expensive problem for the automobile insurance industry, particularly in the area of soft-tissue injuries. Soft-tissue injuries are muscle sprains and strains that cannot be objectively verified by medical evidence. These are often the only types of injuries claimed in low impact accidents. The most common example is a neck sprain/strain, commonly known as “whiplash.” These injuries do not show up on Computer Aided Tomography (CAT) scans or Magnetic Resonance Imaging (MRI) diagnostics. As a result, it is very difficult to prove or disprove that a claimant suffered a soft-tissue injury as a result of a car accident. This difficulty, combined with a public attitude of acceptance of insurance fraud, has resulted in a bodily injury claim fraud rate estimated at 35%-52% by the RAND Institute. This type of fraud is estimated to cost automobile insurance companies between $10-$20 Billion per year.

Insurance companies have a duty to their insureds to promptly pay for valid soft-tissue injury claims. The challenge for insurance claims adjusters is to identify which soft-tissue injury claims are valid in order to fulfill this duty, while denying fraudulent claims that impact insurance company profitability and cause premiums to increase. There can be several specific decision adjusters must make in order to process a soft-tissue injury claim. For example, the adjuster can pay the claim as submitted, pay a reduced amount they negotiate, deny the claim, refer the matter to litigation counsel or request further information such as having an Independent Medical Examination performed. Because there is no objective evidence that these injuries exist, claims adjusters must look at evidence regarding the injury potential of the accident and make judgements about whether the forces were sufficient to cause the claimed injuries. Currently, little information is available to insurance claims adjusters upon which to base claims handling decisions. The available information usually includes photographs of the body damage to the claimant's vehicle, property damage estimates, a police report (which generally includes a diagram of how the cars struck each other) and a statement by the claimant about the accident and their injuries. Essentially, the claims adjuster must to some extent perform the role of an accident reconstruction expert—not to determine conclusively what happened, but to guide their claims handling decisions.

Of these items of evidence, claims adjusters tend to rely most heavily on the photographs of vehicle body damage in order to make claims handling decisions. In general, the greater the body damage the more likely the adjuster is to pay the claim. Conversely, the lesser the body damage the more likely the adjuster is to deny the claim, request further information or analysis, or refer the claim to litigation. There are several fundamental drawbacks caused by this process.

First, the decisions claims adjusters often make based on body damage often run counter to the laws of physics. Automotive engineers constantly improve the ability of vehicle structures to absorb crash energy by crumpling. In many cases the greater the body deformation, the more crash energy that was absorbed by the vehicle structure and not transferred to the body of the occupant. Insurance claims adjusters do not generally have the mathematical background, computing resources or information that would enable them to analyze these photographs in light of the structural characteristics of each vehicle model and other factors that would impact the crash forces for a given accident.

Second, the use of photographs alone ignores the other factors that can have a significant impact on how crash forces are transferred to the body parts of an occupant. It is well established that the dynamics characteristics of seats, seat belts, head restraints and airbags can have a significant effect on injury forces in low impact accidents. In addition, other factors will impact injury potential such as direction of force, occupant dimensions, occupant position and fit within the cabin structures, occupant age and gender. As a result of these deficiencies, several problems arise for the automobile insurance company.

First, the insurance company has difficulty fairly compensating claimants with legitimate soft tissue injuries. Based on the highly inaccurate process used to make claims handling decisions, many of these claimants will have their claim denied or referred to litigation. They may never receive payment from the insurance company for their injuries or lost wages, or may have payment delayed substantially.

Second, the insurance company spends an excessive amount of premiums paying for fraudulent medical and lost wages expenses that are based on fraudulent injury claims.

Third, the insurance company ends up spending an excessive amount of premiums on attorneys' fees and costs associated with resolving these issues in litigation.

Until development of the present invention, there was no viable alternative for the insurance company to resolve these drawbacks in their claims handling process.

### SUMMARY OF THE INVENTION

According to one aspect of the invention, a method for analyzing injuries for insurance claims includes receiving impact data from a claims center, running an occupant simulation, and generating a simulation output.

A more complete understanding of the present invention, as well as well as further features and advantages of the present invention, will be obtained by reference to the following detailed description, drawings and appended claims. The descriptions in this application are explanatory only and are intended to provide further explanation of the invention.

### BRIEF DESCRIPTION OF THE DRAWINGS

FIG. 1a is a diagram of an automobile accident;

FIG. 1b is a Venn diagram of claims data;

FIG. 1c is a simplified diagram of the overall system;

FIG. 2 is a schematic block diagram of the overall system;

FIG. 3 is a flowchart illustrating a process for making a claims-handling decision;

FIG. 6 is a schematic bock diagram of an occupant simulation system;

FIG. 7 is a schematic block diagram of a data management system;

FIG. 8 is a flowchart illustrating a run management process

FIG. 9a is an exemplary account access form;

FIG. 9b is an exemplary user access database;

FIG. 10 is an exemplary claimant specification form;

FIG. 11a is an exemplary vehicle specification form;

FIG. 11b is an exemplary object specification form;

FIG. 12 is an exemplary injury specification form;

FIG. 13 is an exemplary data download form;

FIG. 14 is an exemplary components database;

FIG. 15 is an exemplary case input database;

FIG. 16 is an exemplary case output database;

FIG. 18 is an exemplary expert system for analysis of injury potential;

FIG. 22 is a schematic block diagram of an impact analysis system;

FIG. 23 is a flowchart illustrating an impact management process;

FIG. 24a is an exemplary photo vehicle model;

FIG. 24b is an exemplary stored vehicle model;

FIG. 25 is an exemplary crush analysis overlay;

FIG. 26 is an exemplary crush dimension graphical indicator; and

FIG. 30 is a block diagram for using the system in settlement negotiations.

### DETAILED DESCRIPTION OF THE INVENTION

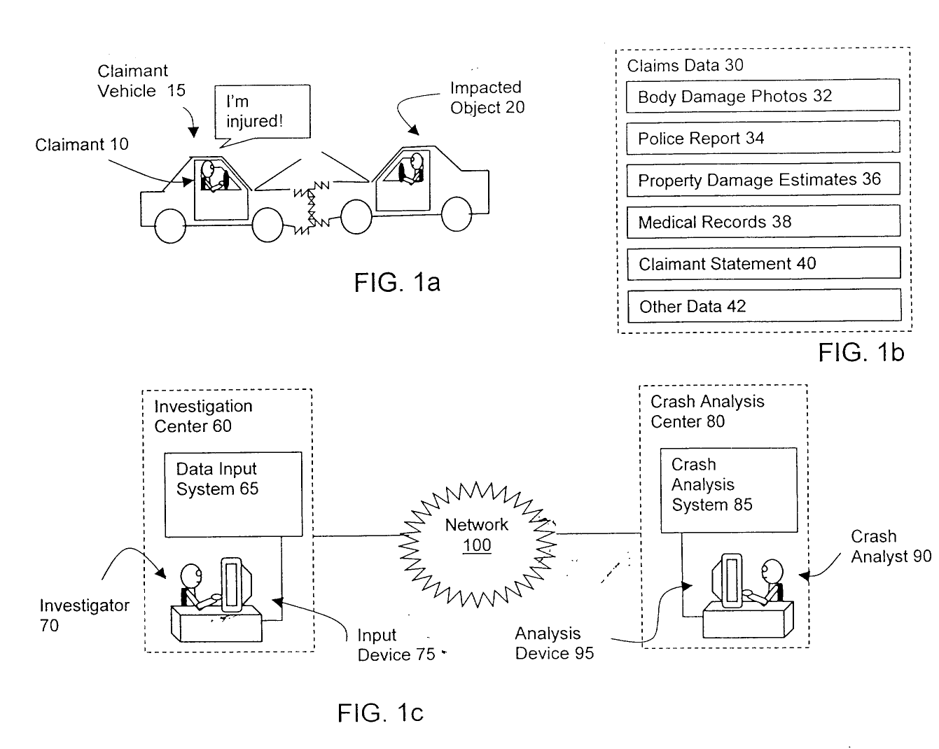

FIG. 1c shows an overview block diagram of the Injury Analysis System which enables remote analysis of the injury potential of an automobile crash. When a vehicle is involved in a crash as shown in FIG. 1b, various forms of Claims Data 30 are generated as shown in FIG. 1c. The Injury Analysis System shown in FIG. 1c enables this Claims Data 30 to be remotely analyzed by a Crash Analysis Center 80.

An automobile crash will typically include at least one Claimant 10 and the Claimant's Vehicle 15 and an Impacted Object 20—shown here as another vehicle. Impacted Object 20 could also be any type of object that causes damage to a vehicle or injuries to a vehicle occupant, such as a pole or tree, or a road surface in the event of a solo-vehicle rollover. A Claimant 10 is defined herein as someone who asserts an insurance claim or lawsuit against an insurance, company, individual or other organization alleging injuries from the crash. Claimant's Vehicle 15 is defined herein as the vehicle which Claimant 10 is riding in at the time of the accident. Claimant 10 could be a passenger, owner or driver.

Various forms of Claims Data 30 shown in FIG. 1b may be generated in different ways. In a typical case, a police officer will respond to the scene of a vehicle crash and will perform some investigative work. This investigative work is usually documented by the police officer in the form of a Police Report 34. Sometimes an insurance claims adjuster will respond to the accident scene and take Body Damage Photos 32. Often, Body Damage Photos are taken by an employee at a body shop that is providing an estimate on either the Claimant Vehicle 15 or the Impacted Object 20 in cases where Impacted Object 20 is also a vehicle. Body Damage Photos 32 could be taken by numerous others, including vehicle occupants, police, witnesses, investigators or attorneys. These photographs can be film photographs or can be digital photographs. After the vehicle has left the scene, it will often be taken to one or more body shops to obtain Property Damage Estimates 36. Property Damage Estimates 36 will list specific vehicle parts that are damaged and are either in need of repair or replacement. Once a Claimant 10 has filed a claim with an insurance company, the insurance company will usually obtain a Claimant Statement 40 about how the accident occurred and how the Claimant 10 was injured and their medical treatment history. Other information may include whether the Claimant 10 has ongoing medical problems, had to miss work, or other information that could relate to the damages the Claimant 10 suffered in the crash. The insurance company will also generally obtain copies of the Medical Records 38 of the Claimant that are relevant to the crash. Other Data 42 may include the results of an independent medical examination, loss of work records or accident reconstruction information.

The Injury Analysis System as shown in FIG. 1c enables an Investigator 70 to obtain an analysis of the injuries claimed in the crash by transferring some of the Claims Data 30 to a remote Crash Analysis Center 80 through Network 100. Investigator may be anyone interested in analyzing the injury potential of a crash, including an insurance claims adjuster, attorney, accident reconstruction professional or a police officer. Investigation Center 60 may be an insurance claims operation, a law firm, an expert witness firm or other organization interested in the analysis of a crash. Network 100 is preferably the Internet, but could be any form of Wide Area Network (WAN). Input Device 75 could be any form of computing device that includes an input device (e.g. keyboard) and a display that can be connected to Network 100. Crash Analysis Center 80 is shown here as including a Crash Analysis System 85 and a Crash Analyst 90. Crash Analysis Center 80 could include multiple Crash Analysts 90 and Analysis Devices 95. Analysis Device 95 could be any form of computing device that includes an input device (e.g. keyboard) and a display that can be connected to Network 100.

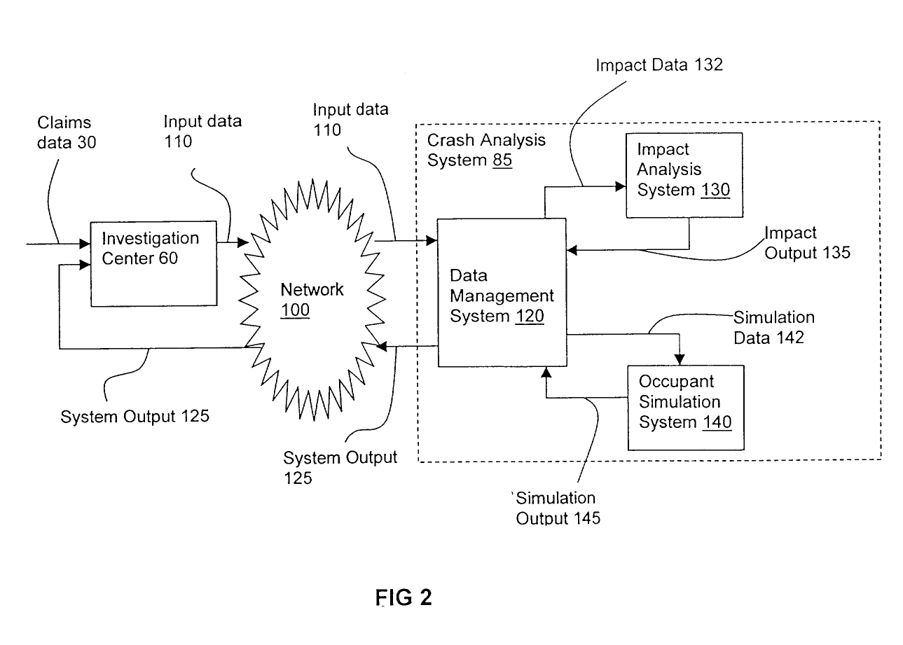

FIG. 2 is a data flow diagram showing greater detail of the Crash Analysis System 85. Crash Analysis System 85 is shown here as including a Data Management System 120, Impact Analysis System 130 and Occupant Simulation System 140. Claims Data 30 flows into the Investigation Center 60. Portions of the Claims Data 30 needed for analysis are selected out, and the resulting Input Data 110 is passed through Network 100 to the Crash Analysis System 85 where it is directed into the Data Management System 120. The Data Management System 120 provides Impact Data 132 to the Impact Analysis System 130 which performs impact analysis and returns Impact Output 135 to the Data Management System 120. The Data Management System 120 also provides Simulation Data 142 to the Occupant Simulation System 140, which performs simulation runs and returns Simulation Output 145 to the Data Management System 120. Data Management System 120 produces System Output 125 which is sent back through Network 100 to the Investigation Center 60.

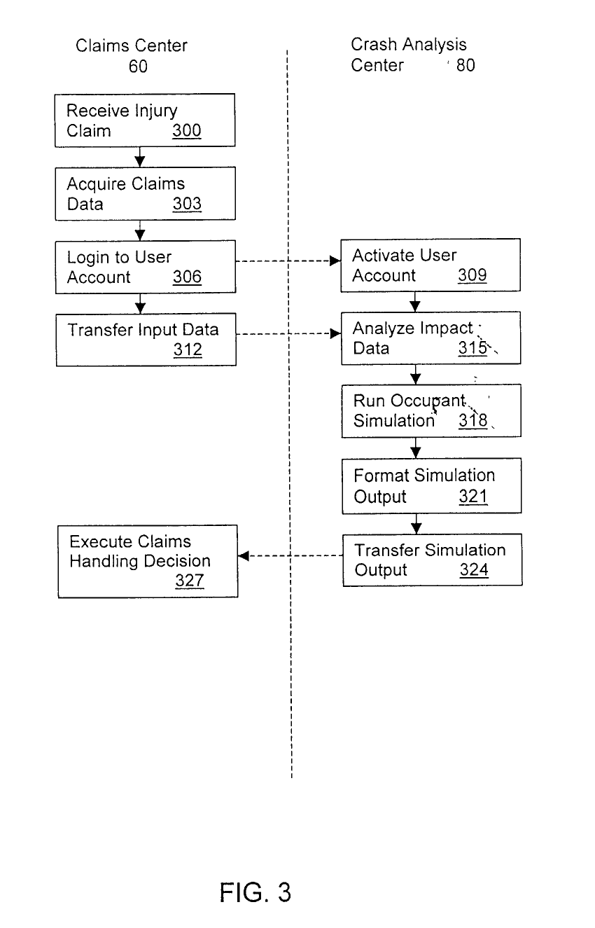

FIG. 3 is a flowchart illustrating a process for executing a claims handling decision. In step 300 a claims center receives an injury claim.

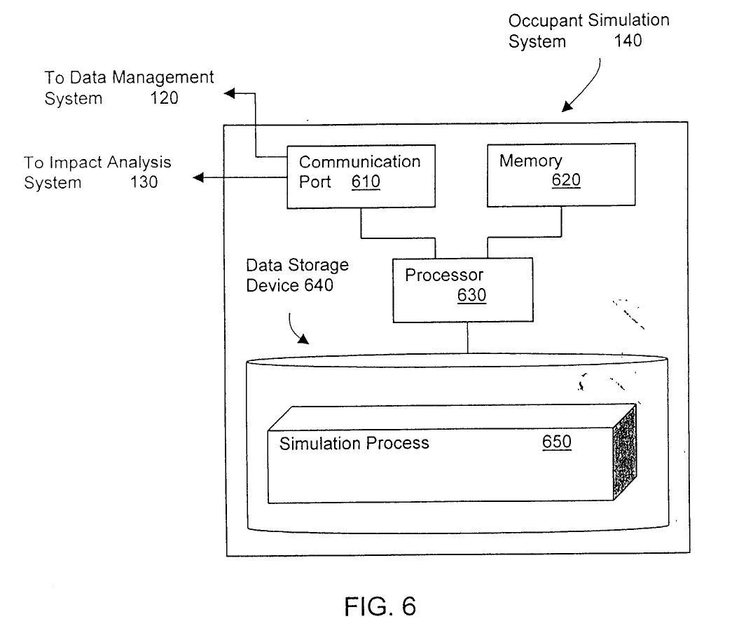

FIG. 6 depicts an Occupant Simulation System 140, which could be any computer housing occupant simulation software that is known in the art. Several occupant simulation software packages exist. The most widely used are the Articulated Total Body (ATB) model and MADYMO—both of which utilize rigid body dynamics for modeling. The ATB model was originally developed by the United States Air Force, and is maintained by Wright Patterson Air Force Base. Commercial versions are available from several companies, including Veridian Engineering in Buffalo, N.Y. MADYMO is sold by TNO Automotive located in the Netherlands and is widely used in evaluating automotive safety and vehicle design by research entities, automobile manufacturers and suppliers, and government agencies. An exemplary Occupant Simulation System 140 is shown in FIG. 6 as a server including a Communication Port 610 in communication with the Data Management System 120 and the Impact Analysis System 130. It is further shown as including a Memory 620, a Processor 630 and a Data Storage Device 640 for storing the computer code that instructs the particular Simulation Process 650 (e.g. ATB, MADYMO).

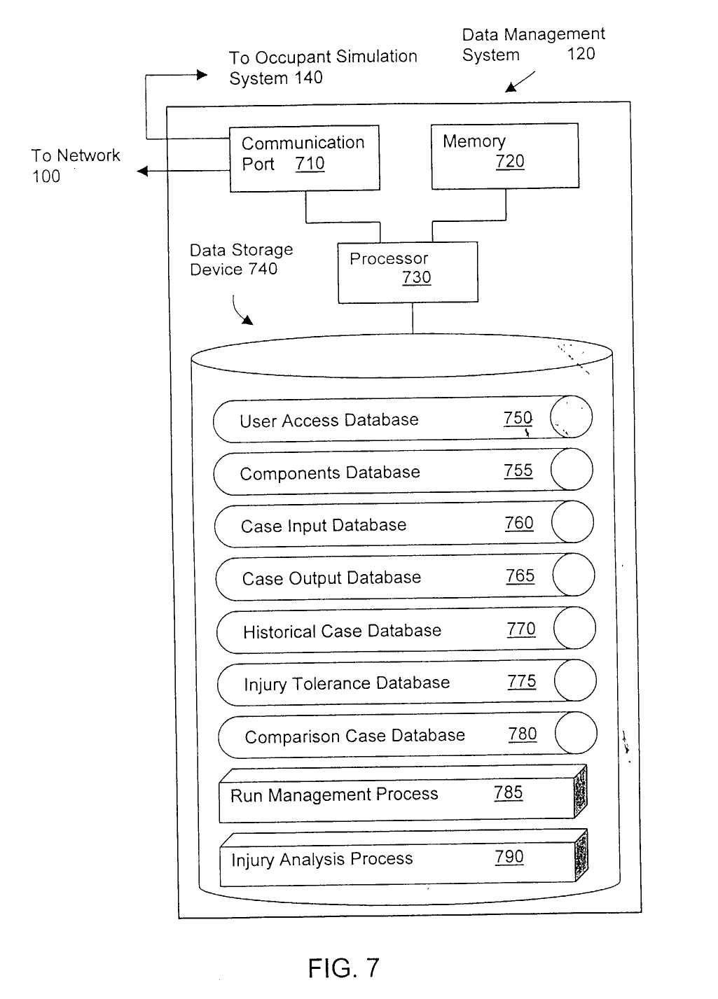

FIG. 7 depicts an exemplary block diagram of a Data Management System 120. The Data Management System 120 includes a Communication Port 710, Memory 720 and Processor 730 for managing the operations of the Crash Analysis System 85, which may include: (1) managing user access to the system and payment for simulation services; (2) managing simulation components; (3) storing and retrieving historical data for users; (4) instructing the Impact Analysis System 130 to perform impact analysis; (5) instructing the Occupant Simulation System 140 to run occupant simulations; (6) analyzing the injury potential of the results from simulation runs; (7) managing the format and display of output data. A Data Storage Device 740 is also shown as part of the Data Management System 120 which may contain a variety of databases including a User Access Database 750 for managing user system access and payment information, Components Database 755 for storing and managing the components used in simulation runs, Case Input Database 760 for capturing and managing the data that is input into the Impact Analysis System 130 and the Occupant Simulation System 140, Case Output Database 765 for storing and managing the results of simulation runs and calculations performed by the Data Management System 120, Historical Case Database 770 for long term storage of user records, Injury Tolerance Database 775 for storing parameter and formulas that correlate Simulation Output 145 to injury potential, and Comparison Case Database 780 for storing simulations that can be used as a reference for injury potential. In addition, Data Storage Device 740 is shown in FIG. 7 as including a Run Management Process 785 for managing the operations of the Occupant Simulation System 140 and the Impact Analysis System 130 and an Injury Analysis Process 790 for analyzing the injury potential for a given simulation run.

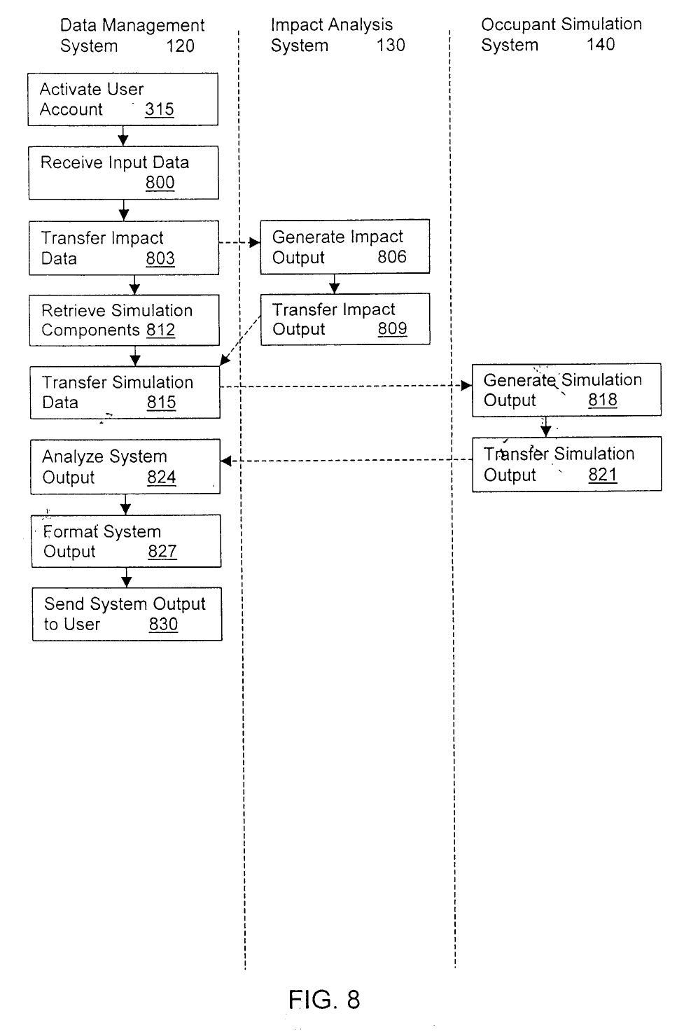

FIG. 8 shows an exemplary Run Management Process 785. Initially, the Data Management System activates a user's account 315. Once an account is activated, the Data Management System receives input data 800 and then sends the input data to the impact analysis system 803. The impact analysis system generates impact output 806, and then transfers it 809 back to the data management system. The data management system retrieves simulation components 812 and then transfers the simulation components and the impact output (“simulation data”) to the occupant simulation system 815. The occupant simulation system generates simulation output 818 and transfers the simulation output to the data management system 821. The data management system then analyzes the system output 824, formats the system output 827 and sends the system output to the user 830.

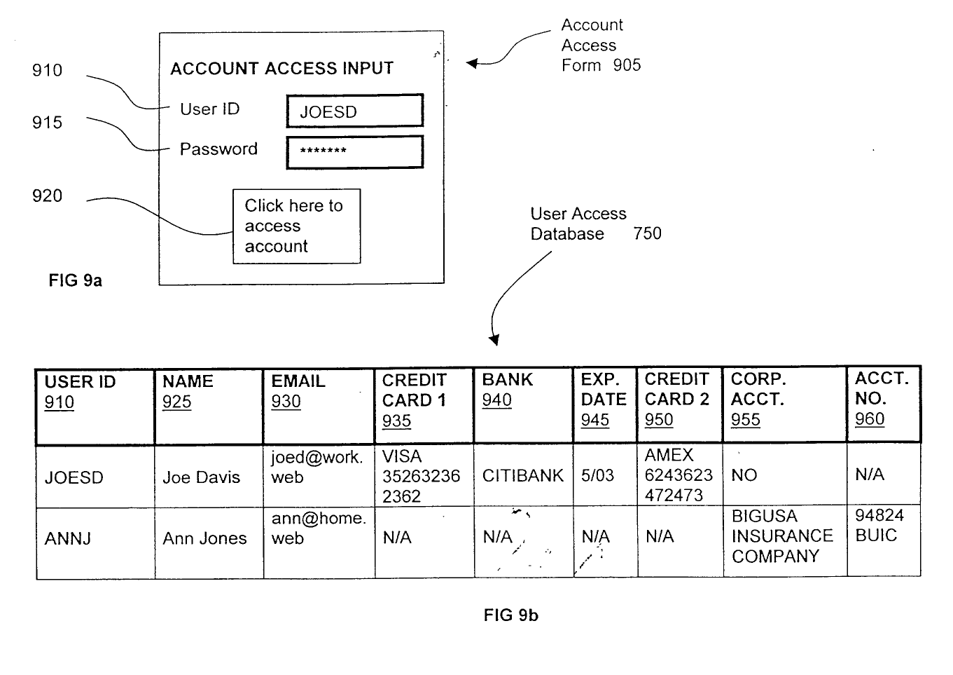

FIG. 9a shows an exemplary Account Access Form 905 that enables a user to input a User ID 910 and Password 915, then instruct 920 the Data Management System 120 to authorize account access. This information is stored within a User Access Database 750, an example of which is shown in FIG. 9b, along with user Name 925, contact information such as Email 930 as well as payment identification information such as the credit card and corporate account information shown by reference numerals 935-960.

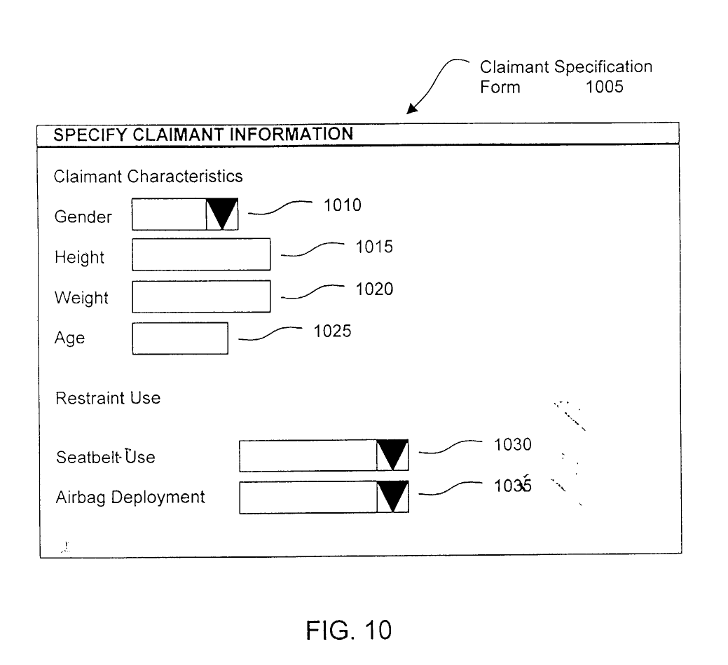

FIG. 10 is an exemplary Claimant Specification Form 1005 that enables a user to cause the Data Management System 120 to generate a virtual representation of Claimant 10 by inputting specifications into the form and clicking the Set Button 835. Here, Claimant 10 is shown generated from specifying Gender 1010, Height 1015, Weight 1020 and Age 1025. Software capable of generating a virtual human from these data inputs is known in the art for human and dummy representation, such as the Bodybuilder and Anthropos products by the TecMath corporation and Mannequin Pro from NexGen Ergonomics. Restraint use for claimant may also be specified, here shown as specifying Seatbelt Use 1030 and Airbag Deployment 1035.

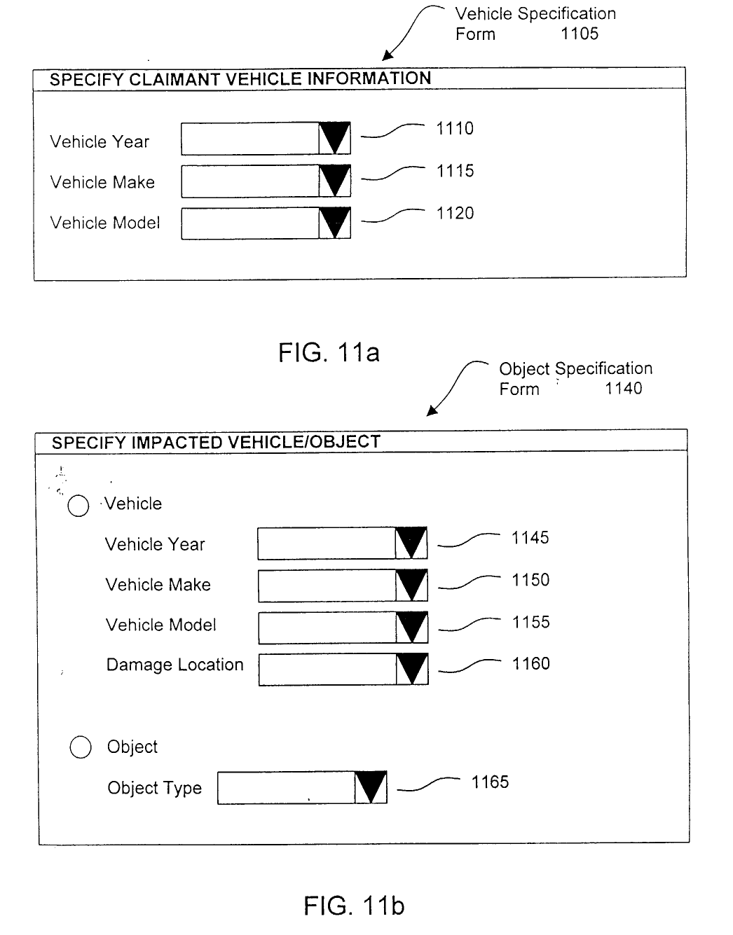

FIG. 11a is an exemplary Vehicle Specification Form 1105 that enables a user to cause the Data Management System to select a specific vehicle file from its Components Database 755 by specifying the vehicle. Here, vehicle is shown specified by Vehicle Year 1110, Vehicle Make 1115 and Vehicle Model 1120. Alternatively, the specific vehicle could be selected by VIN number with Components Database 755 indexing vehicles by VIN number.

FIG. 11b is an exemplary Object Specification Form 1140 that enables a user to cause the Data Management System 120 to select a specific vehicle or object file from its Components Database 755 and communicate to the Damage Location 1160 of the impacted object to the Crash Analysis System 85.

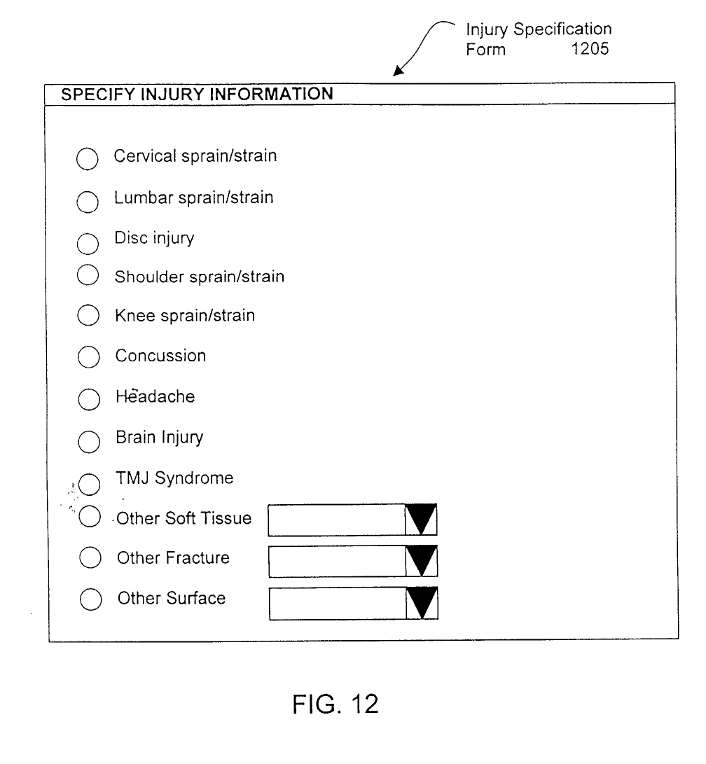

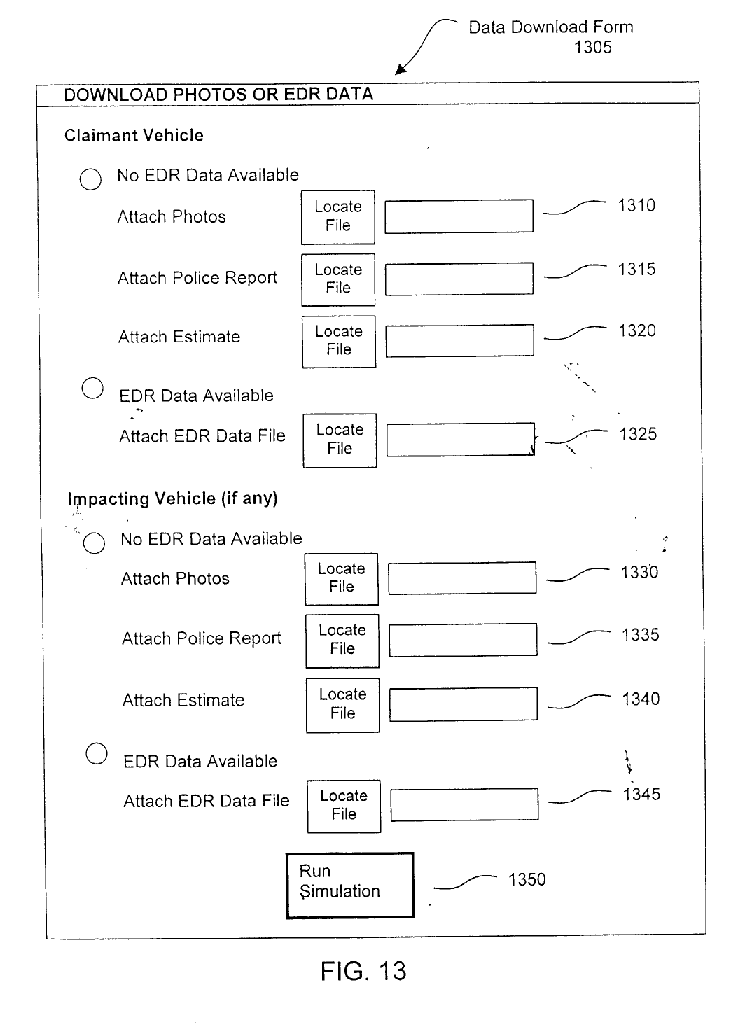

FIG. 12 is an exemplary Injury Specification Form 1205 that enables a user to inform the Crash Analysis System 85 of the anatomical location and severity of the claimed injury. FIG. 13 is an exemplary Data Download Form 1305 that enables a user to download data to the Crash Analysis System 85. Data can be downloaded regarding either the claimant vehicle, the impacting vehicle or both. Claimant vehicle data may include photographs 1310, Police Report 1315, Estimate 1340 or EDR Data File 1325. Similar data may also be downloaded for the impacting vehicle (1330-1345). The user may instruct the Data Management System 120 to run the simulation by clicking the Run Simulation 1350 button.

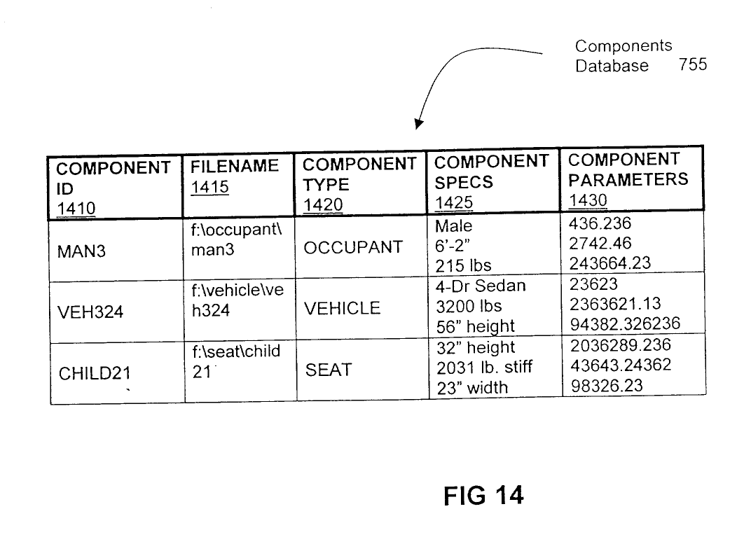

FIG. 14 is an exemplary Components Database 755. Components are shown as including a Component ID 1410, Filename 1415, Component Type 1420, Component Specs 1425 and Component Parameters 1430.

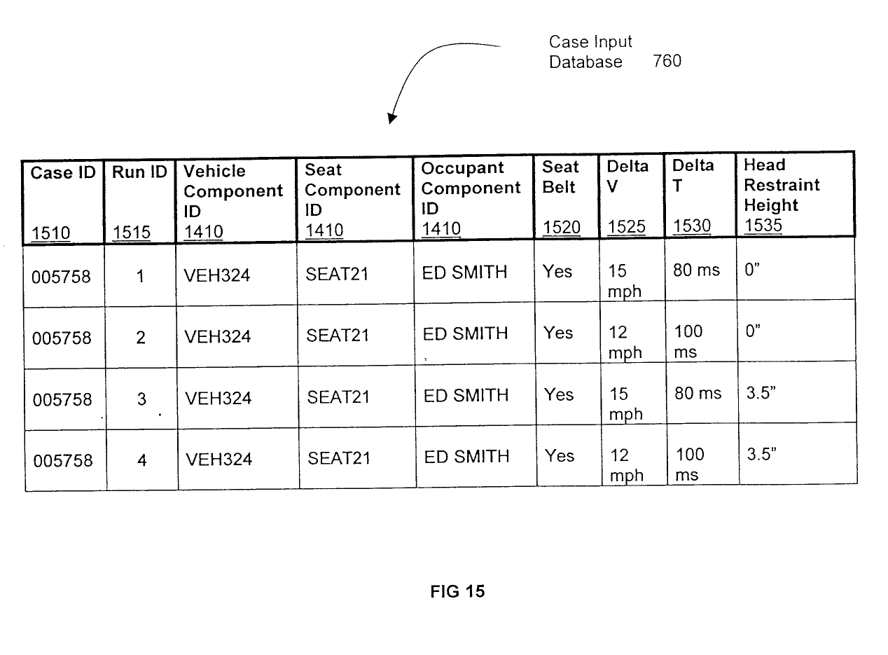

FIG. 15 is an exemplary Case Input Database 760. Case ID 1510 is an identifier for the particular claim that is being analyzed, and could be a court case number or an internal claim number. Run ID 1515 identifies the particular simulation run, which corresponds to a particular set of input conditions and graphical simulation output. Components 1410 are shown as including a vehicle ID, Seat Component ID and Occupant Component ID. Other Input Data 110 are shown in FIG. 15 (1520-1535).

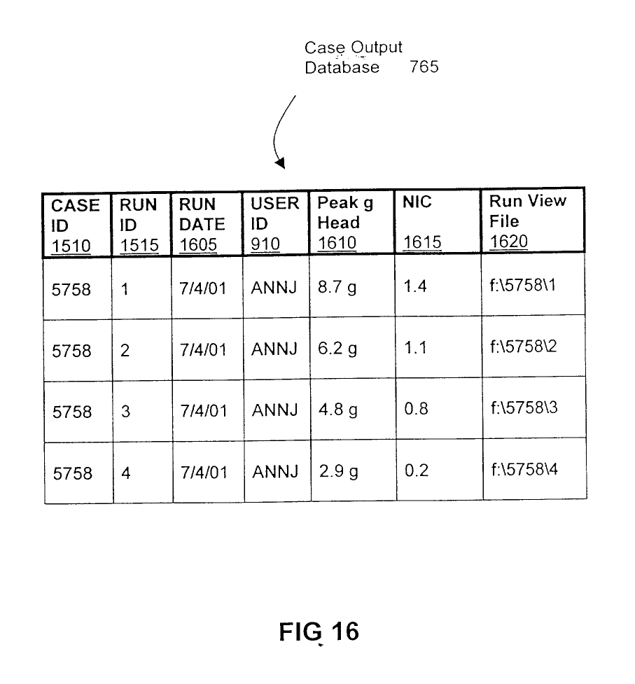

FIG. 16 depicts an exemplary Case Output Database 765. Here shown as including several reference identifiers including Case ID 1510, Run ID 1515, Run Date 1605 and User ID 910. System Output 125 is also shown as including Peak g Head 1610, NIC 1615 and Run View File 1620. Peak G Head 1610 is a common measure of occupant head acceleration and NIC is a standard measure of neck force information in automotive safety. Run View File 1620 contains a particular file location that enables a user to view the graphical simulation output file.

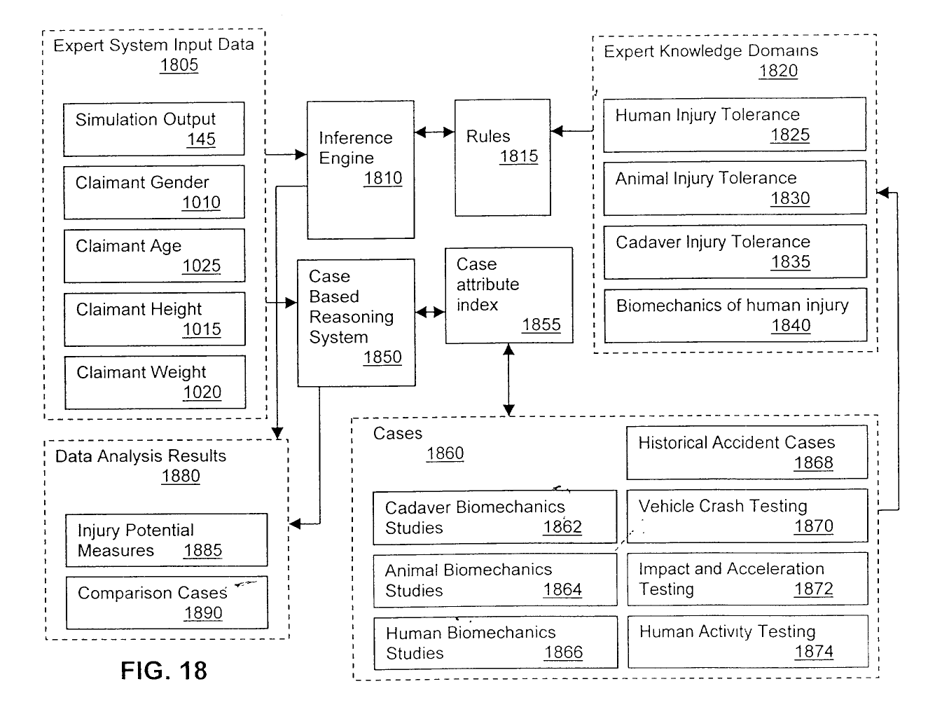

FIG. 18 shows an application within the Crash Analysis System 85 in the form of an expert system which automatically generates Data Analysis Results 1880 based on Expert System Input Data 1805. An Inference Engine 1810 is used to generate Data Analysis Results 1880 based on Rules 1815 Established by experts in various Expert Knowledge Domains 1820 including Human Injury Tolerance 1825, Animal Injury Tolerance 1830, Cadaver Injury Tolerance 1835 and Biomechanics of Human Injury 1840. Data Analysis Results 1880 may also be generated by a Case Based Reasoning System 1850 which utilizes Cases 1860 as a knowledge base by linking attributes of a crash event to attributes of cases using a Case History Attribute Index 1855. Cases 1860 may include Cadaver Biomechanics Studies 1862, Animal Biomechanics Studies 1864, Human Biomechanics Studies 1866, Historical Accident Cases 1868, Vehicle Crash Testing 1870, Impact and Acceleration Testing 1872 and Human Activity Testing 1874.

Inference Engine 1810 may utilize any rules-based logic scheme, including use of Boolean algorithms to generate Data Analysis Results 1880 from Rules 1815. Case Based Reasoning System 1850 may utilize any form of comparison logic scheme, including probability-based algorithms (including Bayesian algorithms) to determine the relative probabilities of the presence or absence of particular injuries.

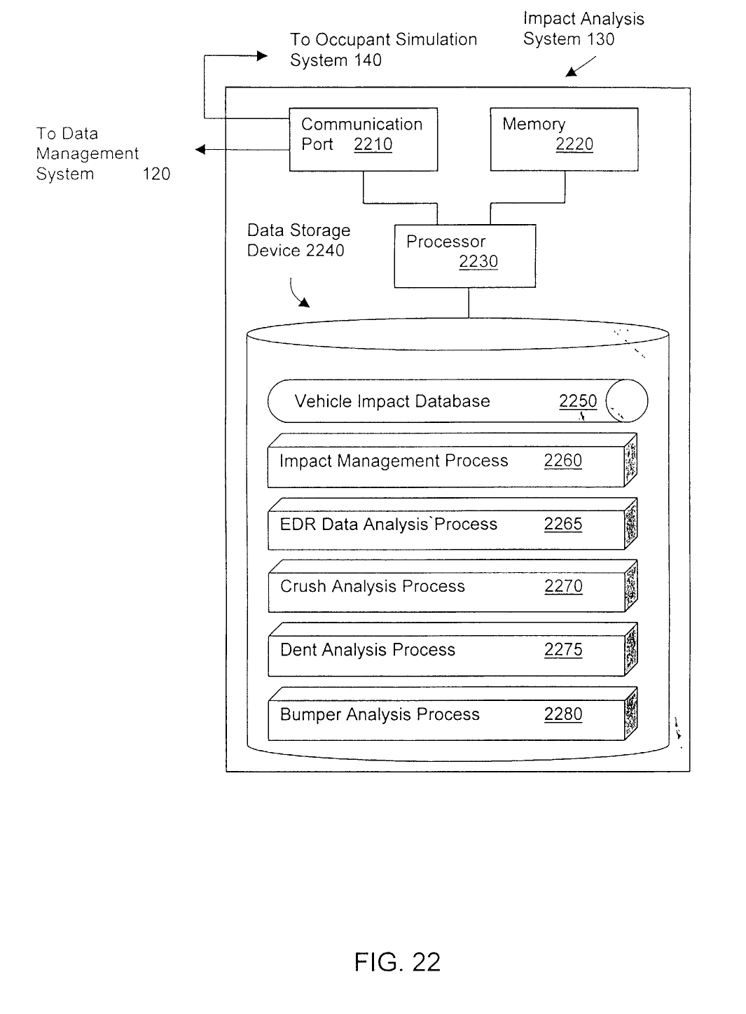

FIG. 22 depicts an exemplary block diagram of an Impact Analysis System 130. The Impact Analysis System 130 includes a Communication Port 2210 in communication with Occupant Simulation System 140 and Data Management System 120. Impact Analysis System 130 further includes a Memory 2220 and Processor 2230 for managing the operations of the Impact Analysis System 130, which include selecting and executing an impact analysis process that assists with the calculation of delta V, peak g and delta t from either body damage information or EDR data. A Data Storage Device 2240 is also shown as part of the Impact Analysis System 130 which may contain a variety of databases, including a Vehicle Impact Database 2250. In addition, Data Storage Device 2240 is shown in FIG. 22 as including an Impact Analysis Process 2260 for managing the operations of the Impact Analysis System 130, an EDR Data Analysis Process 2265 for converting EDR data into simulation input data, a Crush Analysis Process 2270 for converting crush data obtained from vehicle photographs into simulation input data, a Dent Analysis Process 2275 for converting dent data obtained from vehicle photographs and property damage estimates into simulation input data and a Bumper Analysis Process 2280 for using bumper strength measurements to determine the maximum delta V, delta t and peak g for a given impact.

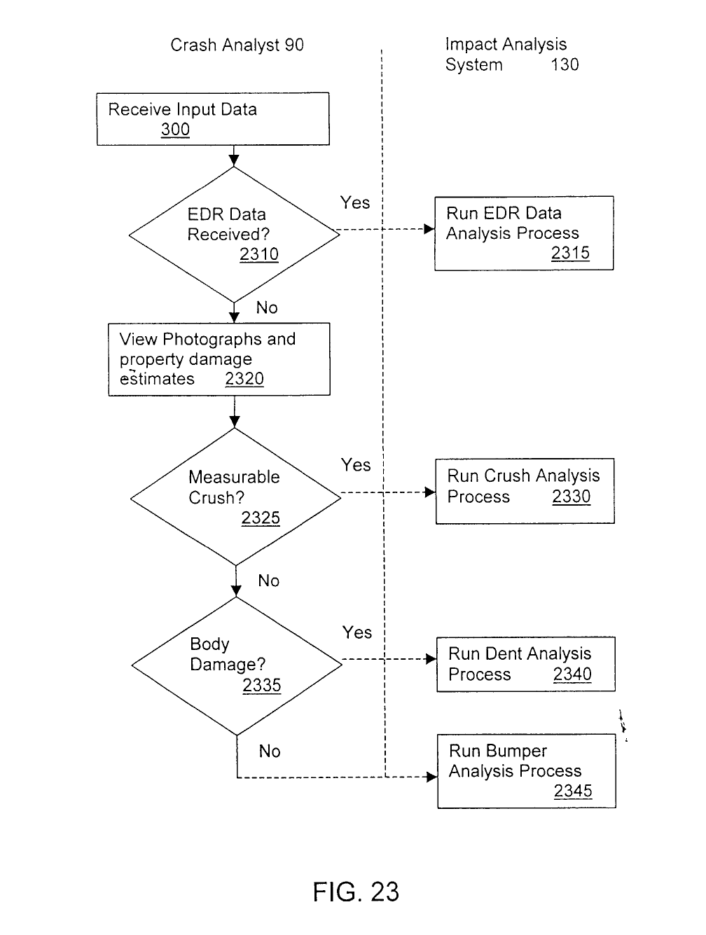

FIG. 23 is a flowchart illustrating an Impact Management Process 2260, which involves interaction between a Crash Analyst 90 and an Impact Analysis System 130. A Crash Analyst 90 will receive Input Data 300 and decide what type of analysis to run within the Impact Analysis System 130. If EDR data is received 2310 the Crash Analyst 90 will instruct the Impact Analysis System 130 to Run EDR Data Analysis Process 2315. If not, the Crash Analyst 90 will view the Photographs and Property Damage Estimates 2320. If Measurable Crush 2325 exists, the Crash Analyst 90 will instruct the Impact Analysis System 130 to Run Crush Analysis Process 2330. If not, the Crash Analyst 90 will determine if Body Damage exists 2335. If so, the Crash Analyst 90 will instruct the Impact Analysis System 130 to Run Dent Analysis Process 2340. If not, the Crash Analyst 90 will instruct the Impact Analysis System 130 to Run Bumper Analysis Process 2345.

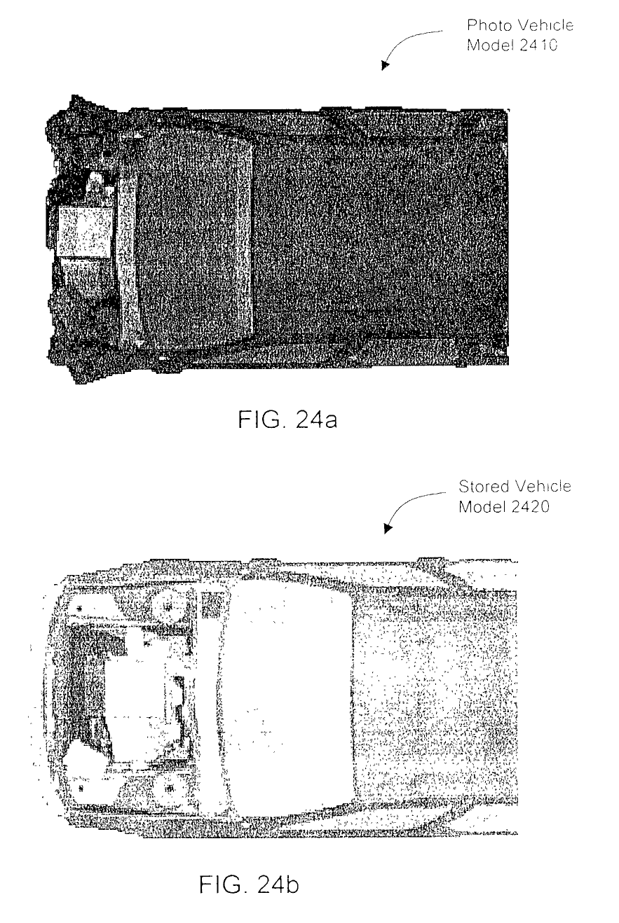

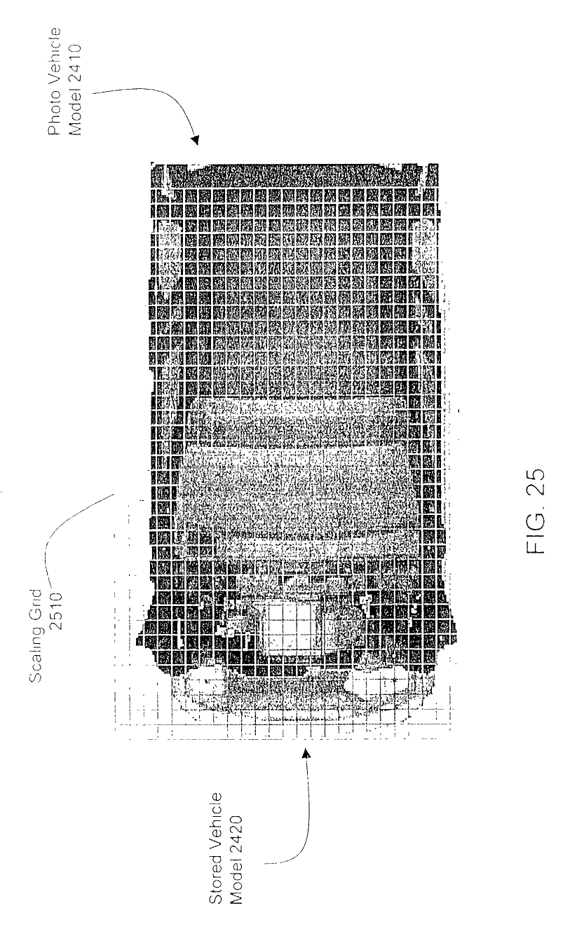

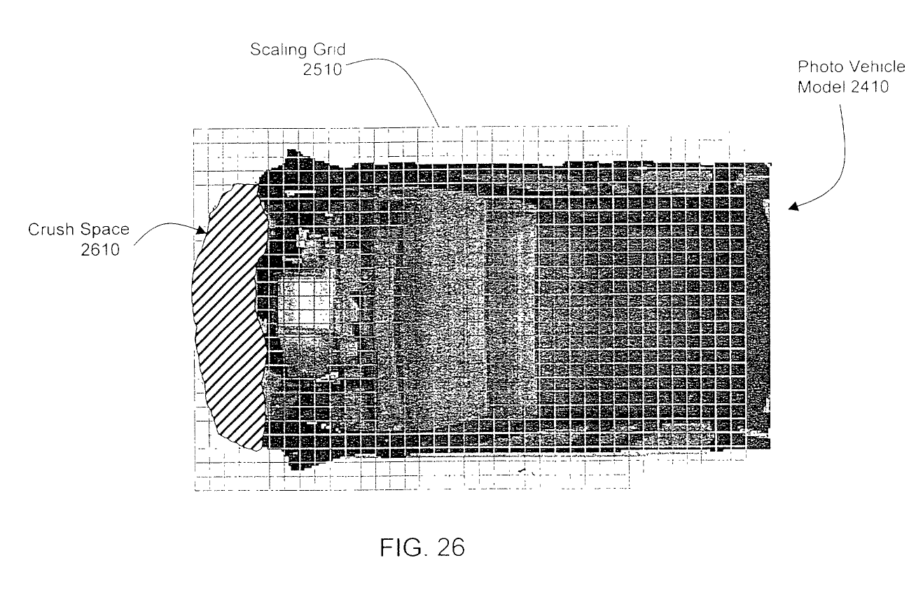

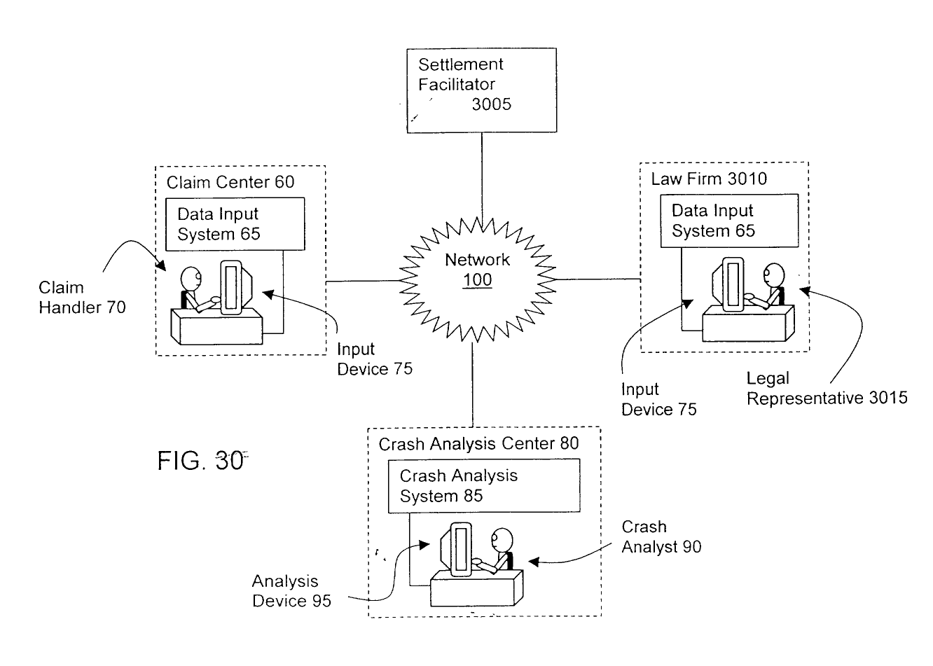

FIG. 24a shows an exemplary Photo Vehicle Model 2410 that is utilized in the Crush Analysis Process 2270. Photo Vehicle Model 2410 is a 3D representation of the Claimant Vehicle 15 or Impacted Object 20 that is created based on photogrammetery analysis of Body Damage Photos 32. Photogrammetery is a process for creating 3D images from 2D photographs. Those skilled in the art of photogrammetry will be familiar with this process, which can be performed using common software packages such as PhotoModeler available from the EOS Corporation. FIG. 24b shows an exemplary Stored Vehicle Model 2420, which is a stored 3D model of a vehicle stored within the Crash Analysis System 85. As shown in FIG. 25, these images are overlaid and imposed on a Scaling Grid 2510. Measurements of the amount of crush present on Photo Vehicle Model 2410 can then be determined based on measuring the dimensional differences between Photo Vehicle Model 2410 and the Stored Vehicle Model 2420. One manner of accomplishing this measurement is to highlight the Crush Space 2610 as shown in FIG. 26, and measure the area occupied by the Crush Space 2610.

Those skilled in the art will understand that the embodiments of the present invention described above exemplify the present invention and do not limit the scope of the invention to these specifically illustrated and described embodiments. The scope of the invention is determined by the terms of the appended claims and their legal equivalents, rather than by the described examples. In addition, the exemplary embodiments provide a foundation from which numerous alternatives and modifications may be made, which alternatives and modifications are also within the scope of the present invention as defined in the appended claims.

What is claimed is:

1. A method for analyzing injuries for insurance claims, the method comprising:
receiving impact data from a claims center;
running an occupant simulation; and
generating a simulation output.
